(19) United States
(12) Patent Application Publication
(10) Pub. No.: US 2025/0258448 A1
(43) Pub. Date: Aug. 14, 2025

(54) TONER AND IMAGE FORMING APPARATUS

(71) Applicant: SHARP KABUSHIKI KAISHA, Osaka (JP)

(72) Inventor: Yoshiaki TOKUMURA, Osaka (JP)

(21) Appl. No.: 19/046,884

(22) Filed: Feb. 6, 2025

(30) Foreign Application Priority Data
Feb. 9, 2024 (JP) 2024-018223

(51) Int. Cl. G03G 9/097; G03G 9/08; G03G 9/087; G03G 9/09

(52) U.S. Cl. CPC G03G 9/09725; G03G 9/0815; G03G 9/08755; G03G 9/08782; G03G 9/0918

(57) ABSTRACT

A toner comprises toner particles and an external additive adhering to surfaces of the toner particles, wherein the toner particle includes a crystalline polyester resin and a wax, the external additive includes organic/inorganic composite fine particles and an associated silica having two or more primary particles being associated with each other, and the toner has a softening point of 110° C. or lower.

### CROSS-REFERENCE TO RELATED APPLICATIONS

The present application claims priority from Japanese Application JP2024-018223, the content of which is hereby incorporated by reference into this application.

### BACKGROUND OF THE DISCLOSURE

### 1. Field of the Disclosure

The present disclosure relates to a toner and an image forming apparatus.

### 2. Description of the Related Art

Conventionally, there has been known a toner.

For example, there is known a method for producing associated silica, where hydrophobic spherical silica fine particles having an average primary particle diameter of 0.01 to 200 nm are reacted in a humidified atmosphere at a temperature of 100 to 500° C. to obtain two or more primary particles having an average particle diameter in a range of 5 to 500 nm associated with each other, and there is known a toner having such an associated silica externally added to a surface of the toner particles.

There is also known a toner including toner particles and organic/inorganic composite fine particles on surfaces of the toner particles, where the organic/inorganic composite fine particles include resin fine particles and inorganic fine particles embedded in surfaces of the resin fine particles, a part of the inorganic fine particles is exposed on the surface of the organic/inorganic composite fine particles, the organic/inorganic composite fine particles satisfy a predetermined relationship, and the organic/inorganic composite particles are externally added to the surfaces of the toner particles.

### SUMMARY OF THE DISCLOSURE

However, in the above toner, when external additives adhering to a surface of a photoreceptor is cleaned with a cleaning blade, the organic/inorganic composite particles may slip through the cleaning blade, or a filming may occur.

Therefore, in view of the above problems, the present disclosure provides a toner and an image forming apparatus by which it is possible to reduce a slip-through from a cleaning blade and reduce a filming without impairing a low-temperature fixability.

One aspect of the present disclosure is a toner including toner particles and an external additive adhering to a surface of the toner particles, in which each toner particle includes a crystalline polyester resin and a wax, the external additive includes organic/inorganic composite fine particles and an associated silica, and a softening point of the toner is 110° C. or lower.

An image forming apparatus according to another aspect of the present disclosure includes the toner, an electrophotographic photoreceptor, and an image former.

As described above, according to the present disclosure, it is possible to provide a toner and an image forming apparatus by which it is possible to reduce a slip-through from a cleaning blade and reduce a filming without impairing a low-temperature fixability.

### BRIEF DESCRIPTION OF THE DRAWINGS

FIG. 1 is a schematic cross-sectional view of a toner according to the present disclosure.

FIG. 2 is an enlarged view of a part II in FIG. 1.

FIG. 3 is a diagram illustrating how an external additive adhering to a surface of a photoreceptor is cleaned by a cleaning blade.

FIG. 4 is a diagram illustrating how the external additive adhering to the surface of the photoreceptor is cleaned by the cleaning blade, and illustrates a case in which the external additive includes only organic/inorganic composite fine particles.

FIG. 5 is a diagram illustrating how the external additive adhering to the surface of the photoreceptor is cleaned by the cleaning blade, and illustrates a case in which the external additive includes only an associated silica.

FIG. 6 is a diagram illustrating how the external additive adhering to the surface of the photoreceptor is cleaned by the cleaning blade, and illustrates a case in which the external additive includes organic/inorganic composite fine particles and an associated silica.

FIG. 7 is a schematic side view illustrating a configuration of main components of an image forming apparatus according to the present disclosure.

### DETAILED DESCRIPTION OF THE DISCLOSURE

A preferred embodiment of the present disclosure will be described in detail with reference to the drawings, below. Note that the present embodiment described below does not unduly limit the content of the present disclosure described in the claims, and not all of the configurations described in the present embodiment are necessarily essential as a solution to the present disclosure.

### Toner

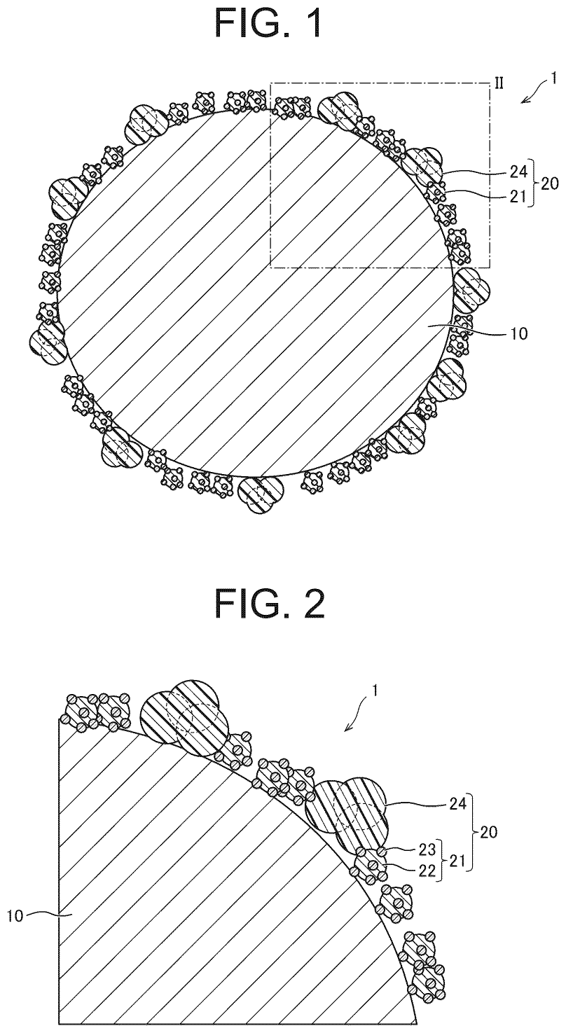

FIG. 1 is a schematic cross-sectional view of a toner 1 according to the present disclosure. FIG. 2 is an enlarged view of a part II in FIG. 1. As illustrated in FIG. 1 and FIG. 2, the toner 1 according to the present disclosure includes toner particles 10 and an external additive 20 adhering to the surface of each toner particle 10. A softening point of the toner 1 is 110° C. or lower. First, a method for producing the toner 1 will be described.

The method for producing the toner 1 includes producing toner particles in which each toner particle 10 (toner core) is produced.

In the producing toner particles, each toner particle 10 serving as a core of the toner 1 is produced. As described above, each toner particle 10 is a particle including a binder resin, a release agent, and a colorant, and a method for producing the toner particle 10 includes, for example, a dry method such as a pulverization method, and a wet method such as a suspension polymerization method, an emulsion aggregation method, a dispersion polymerization method, a solution suspension method, and a melt emulsification method. Each toner particle 10 is added with a crystalline polyester resin and a wax. Therefore, each toner particle 10 includes a crystalline polyester resin and a wax. A method for producing each toner particle 10 by a pulverization method will be described below.

If each toner particle 10 is produced by a pulverization method, a toner composition including a binder resin, a release agent, and optionally a colorant and a charge control agent is dry-mixed in a mixer and then melt-kneaded in a kneader. The kneaded product obtained by melt-kneading is cooled and solidified, and the solidified product is pulverized by a pulverizer. Thereafter, a particle size is adjusted by classification or the like as necessary to obtain each toner particle 10.

Examples of the mixer include a Henschel type mixer such as Henschel Mixer (product name, manufactured by Mitsui Mining Co., Ltd.), Super Mixer (product name, manufactured by Kawata Co., Ltd.), and Mechano Mill (product name, manufactured by Okada Seiko Co., Ltd.), Ongmill (product name, manufactured by Hosokawa Micron Corporation), Hybridization System (product name, manufactured by Nara Machinery Works, Ltd.), and Cosmo System (product name, manufactured by Kawasaki Heavy Industries, Ltd.).

An example of the kneader includes a general kneader such as a twin-screw extruder, a three-roll mill, or a lab blast mill. More specifically, examples of the kneader include a single- or twin-screw extruder such as TEM-100B (product name, manufactured by Toshiba Machine Co., Ltd.), PCM-65/87, and PCM-30 (all of which are product names, manufactured by Ikegai Corporation), and an open-roll type kneader such as Kneadex (product name, manufactured by Mitsui Mining Co., Ltd.). In particular, the open-roll type kneader is preferred.

Examples of a crusher include a jet crusher using a supersonic jet stream to crush a material, and an impact crusher introducing a solidified material into a space formed between a rotor rotating at high speed and a stator (liner) to crush the material.

An example of a classifier includes a cyclone-type wind classifier (rotary type wind classifier).

The toner 1 of the present disclosure produced as described above is mixed with the external additive 20 functioning to improve a powder fluidity, a frictional electrification property, a heat resistance, a long-term storage property, a cleaning property, and to control a surface wear property of a photoreceptor 40, and the external additive 20 adheres to the surface of each toner particle 10.

An example of the external additive 20 includes inorganic fine particles such as silica, titanium oxide, or alumina having an average particle diameter of 7 to 200 nm, and each inorganic fine particle imparted with hydrophobicity by surface treatment in which a silane coupling agent, a titanium coupling agent, or silicone oil are applied to a surface of each inorganic fine particle is preferable because it is possible to reduce a decrease in electrical resistance and charge amount under a high humidity condition.

An amount of the external additive 20 to be added externally is preferably 0.2 to 3 parts by weight relative to each toner particle 10. If the amount is less than 0.2% by weight, it may be difficult to improve a fluidity, whereas if the amount exceeds 3% by weight, a fixing property may decrease. More preferably, the external additive 20 is added externally in an amount of 1.0 to 1.2 parts by weight relative to each toner particle 10. If the amount of the external additive 20 is less than 1.0 part by weight relative to each toner particle 10, a spacer effect may not be expected. On the other hand, if the amount of the external additive 20 is more than 1.2 parts by weight relative to each toner particle 10, the external additive 20 detached from the toner particle 10 may cause a filming.

For the method for adding the external additive 20, a method of mixing each toner particle 10 and the external additive 20 with an air flow mixer such as a Henschel mixer is generally used.

The toner 1 to which the external additive 20 is externally added as described above may be directly used as a one-component developer, or may be used by mixing the toner 1 with a carrier as a two-component developer. If used as the one-component developer, the toner is used alone without any carriers. If used as the one-component developer, the toner is transported by using a cleaning blade 30a and a fur brush to frictionally charge the toner with a developing sleeve and adhering the toner to such a sleeve, to form an image.

The external additive 20 contains organic/inorganic composite fine particles 21 and an associated silica 24.

As illustrated in FIG. 2, each organic/inorganic composite fine particle 21 contains a polymer 22 and the above-mentioned inorganic fine particle (inorganic material 23). The organic/inorganic composite fine particle 21 added as an external additive in the toner 1 according to the present disclosure includes a structure in which the inorganic fine particle (inorganic material 23) is embedded in the polymer 22 so that a plurality of protrusions derived from the inorganic fine particle are present on a surface of the resin particle. Examples of such organic/inorganic composite fine particles 21 include a metal oxide-polymer composite particle in which a metal oxide is covalently bonded to a polymer, as described in Japanese Patent Application Publication No. 2013-92748, and a specific example thereof includes ATLAS (product name) manufactured by Cabot Corporation. Each organic/inorganic composite fine particle may be used after being partially or entirely modified by a surface treatment, and for example, each organic/inorganic composite fine particle surface-treated with a hydrophobizing agent as described in Japanese Patent Application Publication No. 2013-92748 is suitable as an external additive.

As described above, the inorganic material 23 may include metal oxide particles.

Each metal oxide particle is covalently bonded to the polymer 22, a surface of the metal oxide is modified with a first hydrophobizing agent, a moisture content of the metal oxide-polymer composite particle is from 0 wt % to about 10 wt %, as measured after equilibration at 50% relative humidity and 25° C. at about 1 atmosphere, and a density of the metal oxide-polymer composite particle is from about 30% to about 90% of a density of the metal oxide as measured by helium pycnometry.

A moisture content of each metal oxide-polymer composite particle may be from 0 wt % to about 5 wt %, as measured after equilibration at 50% relative humidity and 25° C. at about 1 atmosphere. A toner composition may contain from about 0.5 to about 7 wt % of the metal oxide-polymer composite particle. The metal oxide-polymer composite particle is from about 50 nm to about 500 nm in diameter. At least a portion of the metal oxide particle may be exposed at a surface of the metal oxide-polymer composite particle.

The polymer 22 may include the polymer 22 or a copolymer of a first hydrophobizing agent. The metal oxide particle may include a precipitated or colloidal metal oxide particle. A surface of the metal oxide particle may be modified with a second hydrophobizing agent. The second hydrophobizing agent may be selected from a silazane compound, a siloxane compound, a silane compound, and a silicone fluid having a number average molecular weight of at most 10,000. The first hydrophobizing agent has a formula Si [H3-x(OR1)x]R2Q, where x is 1, 2 or 3, R1 is methyl or ethyl, R2 is an alkyl linker having a general formula CnH2n (n is 1 to 10), and Q is a substituted or unsubstituted vinyl, acrylate, or methacrylate group.

The metal oxide-polymer composite particle may be treated with a third hydrophobizing agent. The third hydrophobizing agent may be an alkylhalosilane or a silicone fluid having a number average molecular weight greater than 10,000. The polymer 22 may be selected from acrylates and methacrylates, olefins, vinyl esters, acrylonitriles, copolymers, and mixtures thereof. The metal oxide-polymer composite particle may have an aspect ratio of from about 0.8 to about 1.2. From about 5% to about 95% of a length of the metal oxide particle may be exposed at a surface of the metal oxide-polymer composite particle.

The associated silica 24 used in the present disclosure is not a secondary particle (aggregate) in which primary particles are loosely attached to one another to be collected, but is a secondary particle in which the primary particles are firmly attached and are not easily disintegrated. Thus, the associated silica 24 means a particle in which two or more primary particles are associated to form a chain, a fiber, or other irregular forms. Examples of such a form include a particle in which two primary particles are associated, a particle in which three or more primary particles are associated in a chain, a particle in which three primary particles are associated at three points, a particle in which four primary particles are associated in a planar or tetrapod-shaped configuration, similarly, a particle in which five or more particles are associated, and a particle in which such associate-type silica groups are combined to each other. Here, the “primary particle” refers to the smallest unit of particles forming a powder. Such particles (associated silica 24) are more advantageous in terms of a shape and an area of an adhesive surface to a toner surface or the like than a particle in an ordinary form in which the primary particles are collected to form a sphere or aggregated to form a lump. It is noted that the “primary particle” mentioned here indicates the smallest unit of particles forming a powder.

Examples of such a form include a particle in which two primary particles are associated, a particle in which three or more primary particles are associated in a chain, a particle in which three primary particles are associated at three points, a particle in which four primary particles are associated in a planar or tetrapod-shaped configuration, similarly, a particle in which five or more particles are associated, and a particle in which such associate-type silica groups are combined to each other.

Here, the “primary particle” refers to the smallest unit of particles forming a powder. The associated-type silica particle has a larger contact (adhesion) area to a surface of a toner base particle than a silica particle in an ordinary form, and therefore, such a particle is difficult to detach from a toner surface. Further, the associated-type silica particle has an irregular shape, and thus, such a particle is less likely to form an aggregate, and therefore, it is possible to suppress an occurrence of a filming while ensuring a sufficient spacer effect.

An average particle diameter of the primary particle of the associated silica 24 used in the present disclosure is preferably 10 nm or more and 200 nm or less. When the average particle diameter of the primary particle of the associated silica is within a range of 10 nm or more and 200 nm or less, it is possible to prevent an aggregation of the toner 1 and to improve a transferability of the toner 1, which are functions required for the external additive 20.

A shape of the primary particle forming the associate-type silica may be any of spherical, egg-like, cubic, and rod-like, but for use as an external additive, the spherical shape is preferred. Further, particle diameters of the primary particle may be different from each other.

The associate-type silica may be produced by a method described in Japanese Patent Application Publication No. 2012-025596, and a commercially available product such as that used in Examples may also be used.

A softening point of the toner 1 according to the present disclosure is 110° C. or lower. The softening point is preferably 90° C. or higher and 110° C. or lower, more preferably 100° C. or higher and 110° C. or lower, and even more preferably 105° C. or higher and 110° C. or lower. If the softening point is less than the lower limit, the external additive 20 is likely to be embedded in the surface of the toner particle 10, and as a result, a dispersibility deteriorates and a dispersibility of the silica particle also deteriorates. Consequently, an amount of film loss on a photosensitive drum may increase and an environmentally charging performance may deteriorate.

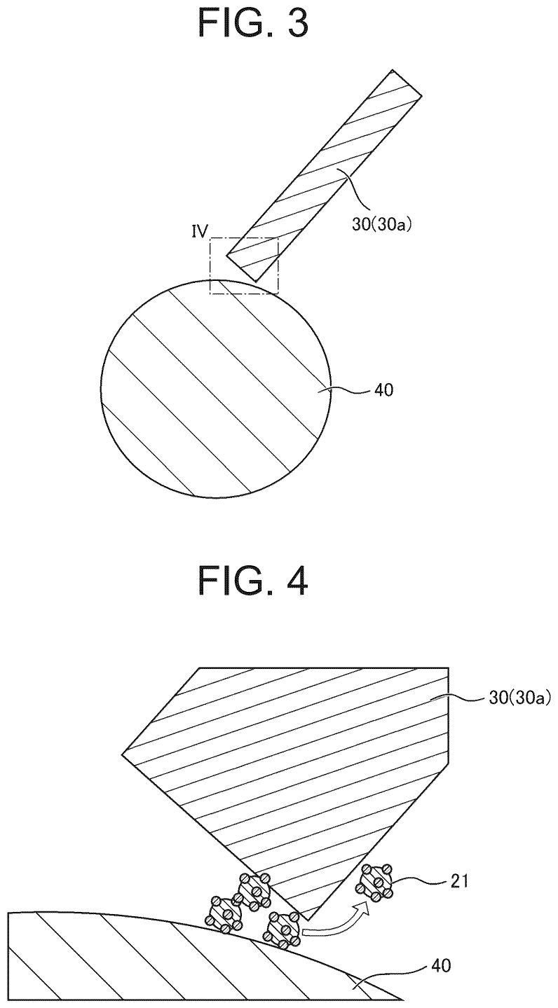

Next, a mechanism by which a slip-through and a filming occur will be described. FIG. 3 is a diagram illustrating how the external additive 20 adhering to the surface of the photoreceptor 40 is cleaned by the cleaning blade 30a. A case where the external additive 20 is only the organic/inorganic composite fine particle 21, a case where the external additive 20 is only the associated silica 24, and a case where the external additive 20 includes both the organic/inorganic composite fine particle 21 and the associated silica 24 will be described below.

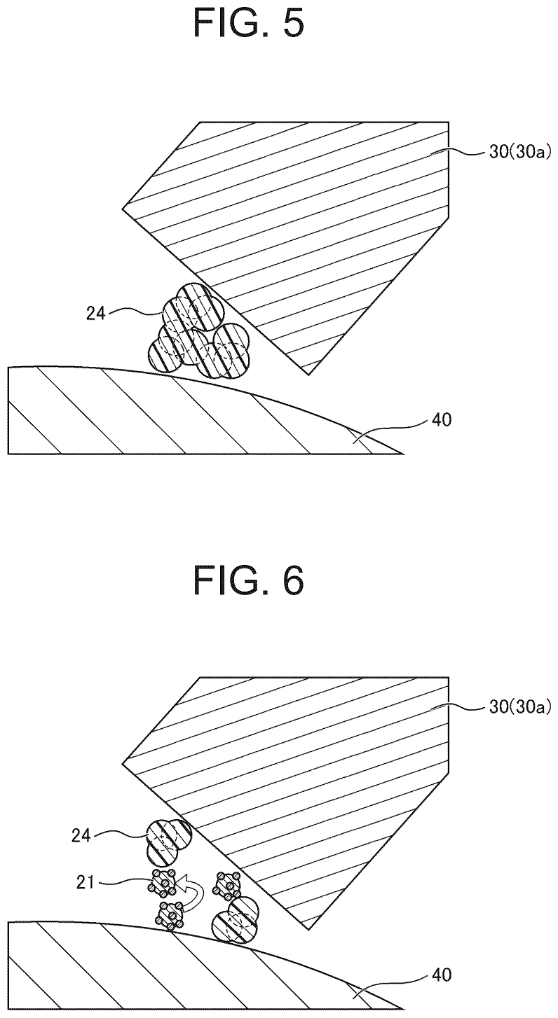

FIG. 4 is a diagram illustrating how the external additive 20 adhering to the surface of the photoreceptor 40 is cleaned by the cleaning blade 30a, and illustrates a case in which the external additive 20 includes only the organic/inorganic composite fine particle 21. FIG. 5 is a diagram illustrating how the external additive 20 adhering to the surface of the photoreceptor 40 is cleaned by the cleaning blade 30a, and illustrates a case in which the external additive 20 includes only the associated silica 24. FIG. 6 is a diagram illustrating how the external additive 20 adhering to the surface of the photoreceptor 40 is cleaned by the cleaning blade 30a, and illustrates a case in which the external additive 20 includes the organic/inorganic composite fine particle 21 and the associated silica 24.

If the external additive 20 includes only the organic/inorganic composite fine particle 21, as illustrated in FIG. 4, the organic/inorganic composite fine particle 21 has the inorganic material 23 on a surface of the polymer 22 and has a structure with a plurality of convex portions, and thus, the external additive 20 slips through the cleaning blade 30a, that is, a so-called slip-through phenomenon occurs.

On the other hand, if the external additive 20 includes only the associated silica 24, as illustrated in FIG. 5, the associated silica 24 tends to aggregate in particles and has an irregular shape, resulting in being prone to remaining on the cleaning blade 30a. Consequently, the external additive 20 aggregates, resulting in what is known as “filming”.

Therefore, if the external additive 20 includes the organic/inorganic composite fine particles 21 and the associated silica 24 as in the toner 1 according to the present disclosure, as illustrated in FIG. 6, when the toner 1 according to the present disclosure includes the associated silica 24 likely to remain in the external additive to a certain extent, it is possible to hold back the organic/inorganic composite fine particles 21, and as a result, it is possible to reduce a slip-through and a filming.

However, if an amount of the associated silica 24 in the toner 1 is too small, it is not possible to hold back the organic/inorganic composite fine particles 21, and thus, a slip-through may easily occur. On the other hand, if the amount of the associated silica 24 in the toner 1 is too large, the associated silica 24 may aggregate, which may cause a filming.

Therefore, it is preferable that the organic/inorganic composite fine particles 21 are contained in the external additive 20 in an amount of 75 to 90 wt %. If a content of the organic/inorganic composite fine particles 21 is less than 75 wt % relative to the external additive 20, a filming may easily occur as described above. On the other hand, if the content of the organic/inorganic composite fine particles 21 is greater than 90 wt % relative to the external additive 20, a slip-through of the external additive 20 may easily occur.

A particle diameter of the organic/inorganic composite fine particles 21 is preferably 70 to 200 nm. If the particle diameter of the organic/inorganic composite fine particles 21 is less than 70 nm, a spacer effect is reduced and the external additive 20 may often slip through the cleaning blade 30a. On the other hand, if the particle diameter of the organic/inorganic composite fine particles 21 is larger than 200 nm, an amount of the particles detached from the toner 1 may often increase. Therefore, if the particle diameter is set within the above range, it is possible to provide a spacer effect to the toner 1 because the organic/inorganic composite fine particles 21 are the external additives 20 having a large particle diameter. In addition, because of a shape having a plurality of convex portions, firm adherence to the surfaces of the toner particles 10 is possible and an uneven distribution to a concave portion of the toner particles 10 is unlikely to occur.

A degree of association of the associated silica 24 is preferably 2.0 to 3.0. It is possible to further reduce a filming. If the degree of association of the associated silica 24 is less than 2.0, a shape of the associated silica 24 approaches that of a spherical silica and the associated silica 24 tends to be unevenly distributed in the concave portion on the surface of the toner particles 10, which may weaken the spacer effect. On the other hand, if the degree of association of the associated silica 24 is greater than 3.0, aggregates are likely to be formed by the cleaning blade 30a, which may worsen a filming. Therefore, when the above range is maintained, the associated silica 24 has an irregular and therefore tends to adhere firmly to the surface of the toner particles 10. However, to exhibit the effect resulting from the irregular shape, a certain degree of association is necessary, and if the degree of association is too high, the particles detach from the cleaning blade 30a with difficulty.

A particle diameter of the associated silica 24 is preferably 100 to 300 nm. If the particle diameter of the associated silica 24 is less than 100 nm, the spacer effect may not be expected. On the other hand, if the particle diameter of the associated silica 24 is greater than 300 nm, aggregates are likely to be formed by the cleaning blade 30a, which may worsen the filming. Therefore, when the above range is maintained, it is possible to prevent formation of aggregates on the cleaning blade 30a and improve the filming.

A particle diameter of the organic/inorganic composite fine particles 21 is preferably smaller than the particle diameter of the associated silica 24. Thus, it is possible to further prevent the slip-through of the organic/inorganic composite fine particles 21.

It is also preferable that a bulk density of the toner 1 is 0.38 or more. Thus, the toner 1 has a good fluidity and is transferred to conform to an unevenness of a paper surface, resulting in high image quality.

It is preferable that an adhesion strength of the external additive 20 to the toner particles 10 is 70% or less. If the adhesion strength of the external additive 20 to the toner particles 10 is greater than 70%, the spacer effect may decrease, and the external additive 20 may be deeply embedded in the surface of the toner particles 10, causing a fluidity of the toner 1 to deteriorate.

As described above, according to the toner 1 of the present disclosure, when both the organic/inorganic composite fine particles 21 and the associated silica 24 are externally added, a low-temperature fixing property is not impaired, and the associated silica 24 suppresses the organic/inorganic composite fine particles 21 from slipping through the cleaning blade 30a, it is possible to solve the problem. It is possible to ensure the fluidity of the toner 1, and thus, it is possible to transfer the toner 1 in accordance with the unevenness of the paper surface, as a result of which it is possible to achieve a high image quality.

### Image Forming Apparatus

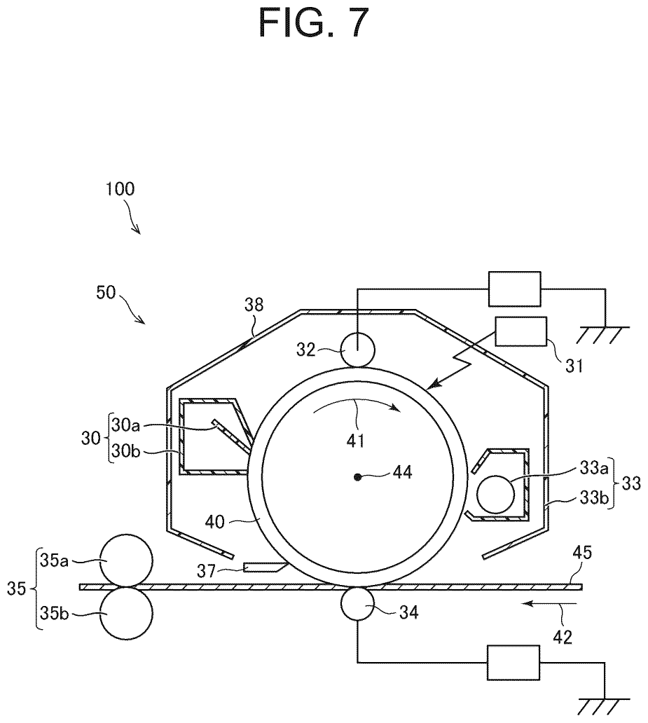

FIG. 7 is a schematic side view illustrating a configuration of main components of an image forming apparatus 100 according to the present disclosure. The image forming apparatus 100 according to the present disclosure includes the above-described toner 1, the photoreceptor 40 (hereinafter also referred to as the electrophotographic photoreceptor 40), and an image former 50. An example of the image forming apparatus 100 includes a laser printer.

The toner 1 described above is used.

The image former 50 charges the electrophotographic photoreceptor 40 with a charging roller 32 to form an image through exposure, transfer, and fixation. The image former 50 will be described, below.

As illustrated in FIG. 7, the image former 50 includes a housing 38, the charger 32 that charges the electrophotographic photoreceptor 40, an exposer 31 that exposes the charged photoreceptor 40 to form an electrostatic latent image, a developer 33 that develops the electrostatic latent image formed by the exposure to form a toner image (to form a visible image), a transferer 34 that transfers the toner image formed by the development onto a recording medium 45, a fixer 35 that fixes the transferred toner image onto the recording medium 45 to form an image, a cleaner 30 that removes and collects the external additive 20 remaining on the electrophotographic photoreceptor 40, and a charge remover (not illustrated) that discharges a surface charge remaining on the electrophotographic photoreceptor 40.

The electrophotographic photoreceptor 40 is rotatably supported by a main body of the image forming apparatus 100, and is driven to rotate about a rotation axis 44 in a direction of an arrow 41 by a driver (not illustrated). The driver is configured to include, for example, an electric motor and a speed reduction gear, and drives the electrophotographic photoreceptor 40 to be rotated at a predetermined peripheral speed by transmitting a driving force to a conductive support body configuring a core body of the electrophotographic photoreceptor 40. The charger (charging machine) 32, the exposer 31, the developer (developing machine) 33, the transferrer (transfer charger) 34, and the cleaner (cleaning machine) 30 are arranged in this order along an outer circumferential surface of the electrophotographic photoreceptor 40 from an upstream side to a downstream side in a rotation direction of the electrophotographic photoreceptor 40 as indicated by the arrow 41.

The charger 32 is a roller charger that uniformly charges an outer circumferential surface of the electrophotographic photoreceptor 40 to a predetermined potential. The exposer 31 includes a semiconductor laser as a light source, and irradiates the surface of the electrophotographic photoreceptor 40 between the charger 32 and the developer 33 with a laser beam output from the light source to expose the charged outer peripheral surface of the electrophotographic photoreceptor 40 according to image information. The surface is repeatedly scanned with the light in a main scanning direction, that is, a direction in which the rotation axis 44 of the electrophotographic photoreceptor 40 extends, and such light beams are focused to form an electrostatic latent image on the surface of the electrophotographic photoreceptor 40 in sequence. That is, an amount of charge on the electrophotographic photoreceptor 40 that is uniformly charged by the charger 32 differs depending on whether the electrophotographic photoreceptor 40 is irradiated with the laser beam, and as a result, the electrostatic latent image is formed.

The developer 33 includes a developing roller 33a being a developer that develops the electrostatic latent image formed on the surface of the electrophotographic photoreceptor 40 by exposure with a developing agent (toner 1), the developing roller 33a being provided facing the electrophotographic photoreceptor 40 and supplying the toner 1 to the outer circumferential surface of the electrophotographic photoreceptor 40, and a casing 33b that rotatably supports the developing roller 33a about a rotation axis parallel to the rotation axis 44 of the electrophotographic photoreceptor 40 and that houses the developing agent including the toner 1 into an internal space therein.

The transferrer 34 is a transfer charger that transfers the toner image being a visible image formed on the outer circumferential surface of the electrophotographic photoreceptor 40 by development, onto a transfer paper being the recording medium 45 supplied between the electrophotographic photoreceptor 40 and the transfer charger 34 from a direction of the arrow 42 by a transporter not illustrated. The transferrer 34 is, for example, a contact-type transfer charger that includes the charger 32 and transfers the toner image onto the transfer paper by applying a charge of the opposite polarity to that of the toner 1 to the transfer paper.

As described above, the cleaner 30 removes the toner 1 and the external additive 20 remaining on the outer circumferential surface of the electrophotographic photoreceptor 40. It is noted that the cleaner 30 removes the toner 1 and the external additive 20 after a transfer operation by the transfer charger 34. The cleaner 30 is a cleaning machine that includes the cleaning blade 30a that peels off the toner 1 and the external additives 20 remaining on the outer circumferential surface of the electrophotographic photoreceptor 40, and a collection casing 30b that houses the above-mentioned toner peeled off by the cleaning blade 30a. The cleaner 30 is provided together with a charge removing lamp (not illustrated).

In the cleaner 30, the toner according to the present disclosure reduces the slip-through from the cleaning blade 30a and reduces the filming.

The image forming apparatus 100 includes a fixing machine being the fixer 35 that fixes a transferred image, on a downstream side of a transport path of the transfer paper 45 passing between the electrophotographic photoreceptor 40 and the transfer charger 34. The fixer 35 includes a heating roller 35a including a heater (not illustrated), and a pressure roller 35b arranged to face the heating roller 35a and pressed against the heating roller 35a to form a contactor. Reference numeral 37 denotes a segmenter 37 that segments the transfer paper 45 from the electrophotographic photoreceptor 40, and reference numeral 38 denotes a casing that houses therein the above-mentioned components of the image forming apparatus 100.

An image forming operation by the image forming apparatus 100 is performed as follows. First, when the electrophotographic photoreceptor 40 is driven to rotate in a direction of an arrow 41 by a driver, by the charger 32 provided upstream in the rotation direction of the electrophotographic photoreceptor 40 from an image forming point of the light by the exposer 31, the surface of the electrophotographic photoreceptor 40 is uniformly charged to a predetermined positive potential.

Next, the exposer 31 irradiates the surface of the electrophotographic photoreceptor 40 with the light according to the image information. In the electrophotographic photoreceptor 40, a surface charge of a portion irradiated with the light is removed by the exposure, and a difference occurs in surface potential between the surface potential of the portion irradiated with the light and the surface potential of a portion not irradiated with the light, and as a result, an electrostatic latent image is formed. From the developer 33 provided downstream in the rotation direction of the electrophotographic photoreceptor 40 from the image forming point of light by the exposer 31, the toner 1 is supplied to the surface of the electrophotographic photoreceptor 40 formed thereon with the electrostatic latent image, and a toner image is formed.

In synchronization with the exposure of the electrophotographic photoreceptor 40, the transfer paper 45 is supplied between the electrophotographic photoreceptor 40 and the transfer charger 34. The transfer charger 34 applies a charge of the opposite polarity to that of the toner 1 to the supplied transfer paper 45, and the toner image formed on the surface of the electrophotographic photoreceptor 40 is transferred onto the transfer paper. The transfer paper 45 onto which the toner image is transferred is transported by the transporter to the fixer 35, and is heated and pressurized in passing through a contact area between the heating roller 35a and the pressure roller 35b of the fixer 35, so that the toner image is fixed onto the transfer paper 45 to form a robust image. The transfer paper 45 on which the image is formed in such a manner is discharged to outside of the image forming apparatus 100 by the transporter.

On the other hand, the toner 1 remaining on the surface of the electrophotographic photoreceptor 40 even after the transfer of the toner image by the transfer charger 34 is peeled off from the surface of the electrophotographic photoreceptor 40 and collected by the cleaner 30. The charge on the surface of the electrophotographic photoreceptor 40 from which the toner 1 is removed in such a manner is removed by light from a charge removing lamp, and the electrostatic latent image on the surface of the electrophotographic photoreceptor 40 disappears. Thereafter, the electrophotographic photoreceptor 40 is further driven to rotate and the series of operations starting from charging are repeated, and as a result, images are continuously formed.

A process cartridge includes the electrophotographic photoreceptor 40 according to the present disclosure, and at least one of the charger 32 that charges the electrophotographic photoreceptor 40, the developer 33 that develops the electrostatic latent image formed by the exposure to form a toner image, and the cleaner 30 that removes the toner 1 remaining on the electrophotographic photoreceptor 40.

For example, the process cartridge is configured by integrating the electrophotographic photoreceptor 40 of the present disclosure, a charging device, a developing device, and a cleaning device with a supporting member. When such a process cartridge is incorporated into the image forming apparatus 100, the image forming apparatus 100 includes each of the components of the process cartridge. When the process cartridge is detachable and attachable from and to the image forming apparatus 100, it is easy to replace the process cartridge when the process cartridge is worn out.

As described above, according to the image forming apparatus 100 of the present disclosure, it is possible to reduce a slip-through from the blade and reduce a filming without impairing a low-temperature fixing property.

### EXAMPLE

The toner according to the present disclosure will be specifically described below with reference to examples and comparative examples, but the present disclosure is not limited to the examples described here.

### Example 1

According to the above-mentioned particle production process, toner particles (toner cores) were obtained.

Next, 1.0 part by mass of silica particles “R976S” (manufactured by Nippon Aerosil Co., Ltd., particle diameter: 7 nm) was added to 100 parts by mass of the obtained toner particles, an airflow mixer (Henschel mixer, manufactured by Mitsui Mining Co., Ltd. (now Nippon Coke & Engineering Co., Ltd.), model: FM20C) with the tip speed of the mixing blade set to 40 m/s, was used, and the following ingredients were premixed for five minutes (mixing).
Colorant: 7% by mass of C.I. Pigment Blue 15:3 (DIC Corporation)
Release agent: 5% by mass of monoester wax (manufactured by NOF Corporation, product name: WEP-3)
Charge control agent: 1% by mass of salicylic acid compound (Orient Chemical Industry Co., Ltd., product name: Bontron E-84)

Next, an open roll type continuous kneader (manufactured by Mitsui Mining Co., Ltd. (now Nippon Coke & Engineering Co., Ltd.), model: MOS320-1800) was used to melt and knead the materials to obtain a molten and kneaded product (kneading). Open roll setting conditions were as follows: a heating roll supply side temperature was set to 130° C., a discharge side temperature was set to 100° C., a cooling roll supply side temperature was set to 40° C., and a discharge side temperature was set to 25° C. A heating roll and a cooling roll used were rolls having a diameter of 320 mm and an effective length of 1,550 mm, and a gap between the rolls on both a supply side and a discharge side was set to 0.3 mm. A rotation speed of the heating roll was set to 75 rpm, a rotation speed of the cooling roll to 65 rpm, and a supply amount of the toner raw material was set to 5.0 kg/h.

The obtained molten and kneaded product was cooled with a cooling belt and then coarsely pulverized by using a speed mill including a φ2 mm screen to obtain a coarsely pulverized product. The obtained coarsely pulverized product was finely pulverized by using a jet pulverizer (manufactured by Nippon Pneumatic Mfg. Co., Ltd., model: IDS-2) to obtain a finely pulverized product (finely pulverizing).

Next, the obtained finely pulverized product was classified by using an elbow jet classifier (manufactured by Nittetsu Mining Co., Ltd., model: EJ-LABO) to obtain toner particles (classifying).

External addition conditions are as follows.

100 parts by mass of the obtained toner particles were added with 1.0 parts by mass of silica particles “R976S” (manufactured by Nippon Aerosil Co., Ltd., particle diameter: 7 nm), and stirred for four minutes in an airflow mixer (Henschel mixer, manufactured by Mitsui Mining Co., Ltd. (now Nippon Coke & Engineering Co., Ltd.), model: FM20C) with the tip speed of the mixing blade set to 40 m/s. Then, an external additive A and an external additive B were prepared. The external additive A is an organic/inorganic composite fine particle and the external additive B is an associated silica.

Thereafter, 0.9 parts by mass of the external additive A and 0.2 parts by mass of the external additive B were added to the toner particles, and the mixture was stirred for two minutes with the tip speed of the air flow mixer set to 40 m/see to adhere the external additives to obtain a toner according to Example 1.

Details of the toner obtained in Example 1 are shown in Table 1.

### Example 2

The particle diameter of the external additive A was changed to 150 nm, and thus, a toner according to Example 2 was obtained. The other conditions were similar to those in Example 1.

### Example 3

The particle diameter of the external additive A was changed to 300 nm, and thus, a toner according to Example 3 was obtained. The other conditions were similar to those in Example 1.

### Example 4

The particle diameter of the external additive A was changed to 50 nm, and thus, a toner according to Example 4 was obtained. The other conditions were similar to those in Example 1.

### Example 5

The degree of association of the external additive B was adjusted to be 2.8, and thus, a toner according to Example 5 was obtained. The other conditions were similar to those in Example 1.

### Example 6

The degree of association of the external additive B was adjusted to be 5, and thus, a toner according to Example 6 was obtained. The other conditions were similar to those in Example 1.

### Example 7

The particle diameter of the external additive B was changed to 220 nm, and thus, a toner according to Example 7 was obtained. The other conditions were similar to those in Example 1.

### Example 8

The particle diameter of the external additive B was changed to 330 nm, and thus, a toner according to Example 8 was obtained. The other conditions were similar to those in Example 1.

### Example 9

The particle diameter of the external additive B was changed to 70 nm, and thus, a toner according to Example 9 was obtained. The other conditions were similar to those in Example 1.

### Example 10

The amounts of the external additive A and the external additive B were changed to 0.3 parts by weight and 0.1 parts by weight respectively, and thus, a toner according to Example 10 was obtained. The other conditions were similar to those in Example 1.

### Example 11

The amounts of the external additive A and the external additive B were changed to 1.8 parts by weight and 0.4 parts by weight, respectively, and thus, a toner according to Example 11 was obtained. The other conditions were similar to those in Example 1.

### Example 12

The amounts of the external additive A and the external additive B were changed to 0.6 parts by weight and 0.5 parts by weight, respectively. A toner according to Example 12 was obtained so that a weight ratio of the external additive A to the external additive B was 6:5. The other conditions were similar to those in Example 1.

### Example 13

The amounts of the external additive A and the external additive B were changed to 1.0 parts by weight and 0.1 parts by weight, respectively. A toner according to Example 13 was obtained so that a weight ratio of the external additive A to the external additive B was 10:1. The other conditions were similar to those in Example 1.

### Example 14

The bulk density of the toner was adjusted to 0.36, and thus, a toner according to Example 14 was obtained. The other conditions were similar to those in Example 1. At this time, an adhesion strength of the external additive to the toner particles was 75%.

### Comparative Example 1

In Comparative Example 1, the external additive A including the organic/inorganic composite fine particles was not added to the toner particles, and only the external additive B was added to obtain a toner according to Comparative Example 1. After the external additives were added, the mixture was stirred for four minutes. The other conditions were similar to those in Example 1.

### Comparative Example 2

In Comparative Example 2, the external additive B including the organic/inorganic composite fine particles was not added to the toner particles, and only the external additive A was added to obtain a toner according to Comparative Example 2. The other conditions were similar to those in Example 1.

### Comparative Example 3

In Comparative Example 3, the external additive B including the organic/inorganic composite fine particles was not added to the toner particles, and only the external additive A was added so that the amount was 0.9 parts by weight relative to the toner particle. In addition, a spherical silica of 110 nm was added so that the amount was 0.2 parts by weight relative to the toner particles. In such a manner, a toner according to Comparative Example 3 was obtained. The other conditions were similar to those in Example 1. It is noted that the spherical silica was added to obtain a spacer effect.

### Comparative Example 4

In Comparative Example 4, the external additive A including the organic/inorganic composite fine particles was not added to the toner particles, and only the external additive B was added so that the amount was 0.2 parts by weight relative to the toner particle. In addition, a spherical silica of 110 nm was added so that the amount was 0.9 parts by weight relative to the toner particles. In such a manner, a toner according to Comparative Example 4 was obtained. The other conditions were similar to those in Example 1.

### Comparative Example 5

In Comparative Example 5, in the mixing, a blending ratio was changed to 87% by mass of an amorphous polyester resin and 0% by mass of a crystalline polyester resin to obtain toner particles having a softening point different from the above. The other conditions were similar to in Example 1, and a toner according to Comparative Example 5 was obtained.

A low temperature offset is evaluated as follows.

The prepared developing agent and toner were filled into a commercially available copying machine (product name: MX-5111FN, manufactured by Sharp Corporation), a test document of A4 size having a rectangular solid image of 20 mm in height and 50 mm in width was copied, and whether a low-temperature offset occurred on a recording medium (product name: PPC sheet SF-4AM3, manufactured by Sharp Corporation) was examined. At this time, an amount of toner adhering to a solid image area was set to 0.5 mg/cm² and a fixing roller temperature was set to 135° C.

It is noted that the low-temperature offset means a phenomenon that occurs when the toner does not fix to a recording sheet during fixing and the toner adheres again to the recording sheet after the fixing roller makes one revolution with the toner being adhering to the fixing roller. Also, a filming resistance was evaluated according to the following criteria.
Good: No toner re-adhesion to the recording sheet is observed
Bad: Toner re-adhesion to the recording sheet is clearly observed

The filming was evaluated as follows.

The prepared developer and toner were filled into the developing device and the toner cartridge of a color multifunction machine (manufactured by Sharp Corporation, model: MX-5100FN), respectively. Next, a continuous print test using 50,000 A4 sheets was performed in an environment of a temperature of 25° C. and a humidity of 5% so that a square solid image (ID=1.45 to 1.50) with a side length of 10 mm was formed at three positions, that is, a center and both ends in an axial direction of the developing roller.

Thereafter, a solid image (ID: 1.6 to 1.8) and halftone (HT) image (ID: 0.5 to 0.7) were output onto an A3 sheet, and the resulting images were visually observed to evaluate the filming resistance according to the following criteria.
Excellent: There are no image defects (white streaks, and the like) in both the solid and HT images, and no streaks are observed on a photoreceptor surface
Good: There are no image defects (white streaks, and the like) in both the solid and HT images, but some streaks are observed on the photoreceptor surface
Available: There are no image defects (white streaks, and the like) in the solid image, but slight image defects (white streaks, and the like) are observed in the HT image, and streaks are partially observed on the photoreceptor surface
Bad: There are defects (white streaks, and the like) in both the solid image and the HT image, and streaks are observed all over the photoreceptor surface.

A method for measuring a softening point of the toner particles is as follows.

A flow characteristic evaluation device (product name: Flow Tester CFT-100C, manufactured by Shimadzu Corporation) was used to heat 1 g of a sample at a temperature increase rate of 6° C. per minute, and a load of 20 kgf/cm² (9.8×105 Pa) was applied, and a temperature at which the sample started to flow out of a die (nozzle diameter: 1 mm, length: 1 mm) was determined as a softening temperature. The softening points of the toners according to Examples 1 to 14 and Comparative Examples 1 to 4 were 110° C., and the softening point of the toner according to Comparative Example 5 was 125° C.

A transferability was evaluated as follows.

A test copying machine modified from a digital copying machine (manufactured by Sharp Corporation, model: MX-5100FN) was used, a secondary transfer current was changed from −45 μA to −55 μA, and images were output under the following conditions.

ID on the sheet was then measured, and ID differences between the four corners and the center of the square were determined as density unevenness and a median, respectively.
NN environment (temperature: 25° C., humidity: 50%)
Sheet (manufactured by Sharp Corporation, PPC sheet, model: SF-4AM3)
Amount of toner adhering to transfer belt (black 0.45 to 0.5 mg/cm²)
Solid image (center of sheet surface, square of 50 mm in height and 50 mm in width)
Excellent: (ID: 1.40 or more and density unevenness less than 0.05)
Good: (ID: 1.40 or more and density unevenness 0.05 or more)
Available: (ID: less than 1.40 and density unevenness less than 0.05)
Bad: (ID: less than 1.40 and density unevenness 0.05 or more)

A method for measuring a fluidity of the toner is as follows.

A weight of 30 ml of the toner was measured in 180 seconds by using a bulk density measuring device (manufactured by Ito Seisakusho Co., Ltd., JIS-K-5101), and a bulk density of the toner was taken as a flowability value.

An adhesion strength of the external additive to the toner particles is as follows.

An adhesion strength of each external additive to the toner particles (toner base particles) was measured according to the following procedures (1) to (7). It is noted that a silica in the expression “adhesion strength of silica” refers to a silica added as an external additive to the toner (not a part of the fine powder), rather than a silica added to a core of the fine powder.

(1) 2.0 g of a toner is added to 40 ml of an aqueous solution of Triton (polyoxyethylene octylphenyl ether) having a concentration of 0.2% by mass, and the mixture is stirred for one minute.

(2) The aqueous solution is irradiated with ultrasonic waves using an ultrasonic homogenizer (manufactured by Nippon Seiki Seisakusho Co., Ltd., model: US-300T) (output: 40 μA, four minutes).

(3) The aqueous solution irradiated with the ultrasonic waves is left to stand for three hours, and the toner and liberated external additives are separated.

(4) After a supernatant is removed, approximately 50 ml of pure water is added to a precipitate and stirred for five minutes.

(5) The mixture is subjected to suction filtration by using a membrane filter having a pore diameter of 1 μm (manufactured by Advantec Co., Ltd.).

(6) A toner remaining on the filter is vacuum-dried overnight.

(7) A fluorescent X-ray analyzer (manufactured by Rigaku Corporation, model: ZSX Primus II) is used to analyze a strength of an element (Si) in the external additive of 1 g of the toner before and after the series of processing (1) to (6) above, and an adhesion strength of the external additive to the toner particles is calculated according to the following formula.

Silica adhesion strength (%)={(Si strength after treatment)/(Si strength before treatment)}×100

Conditions and results of Examples 1 to 11 and Comparative Examples 1 to 4 are shown in Table 1.

TABLE 1

| | | External additive A | | External additive B | | | Spherical Silica | | |
|---|---|---|---|---|---|---|---|---|---|
| | Toner | | Parts by | | | Parts by | | Parts by | Weight |
| | softening | Particle | mass | Degree of | Particle | mass | Particle | mass | ratio |
| Example | point | diameter | (Part) | association | diameter | (Part) | diameter | (Part) | (A:B) |
| Example 1 | 110° C. | 85 nm | 0.9 | 2.4 | 150 nm | 0.2 | — | — | 9:2 |
| Example 2 | | 150 nm | 0.9 | 2.4 | 150 nm | 0.2 | — | — | 9:2 |
| Example 3 | | 300 nm | 0.9 | 2.4 | 150 nm | 0.2 | — | — | 9:2 |
| Example 4 | | 50 nm | 0.9 | 2.4 | 150 nm | 0.2 | — | — | 9:2 |
| Example 5 | | 85 nm | 0.9 | 2.8 | 150 nm | 0.2 | — | — | 9:2 |
| Example 6 | | 85 nm | 0.9 | 5 | 150 nm | 0.2 | — | — | 9:2 |
| Example 7 | | 85 nm | 0.9 | 2.4 | 220 nm | 0.2 | — | — | 9:2 |
| Example 8 | | 85 nm | 0.9 | 2.4 | 330 nm | 0.2 | — | — | 9:2 |
| Example 9 | | 85 nm | 0.9 | 2.4 | 70 nm | 0.2 | — | — | 9:2 |
| Example 10 | | 85 nm | 0.3 | 2.4 | 150 nm | 0.1 | — | — | 9:2 |
| Example 11 | | 85 nm | 1.8 | 2.4 | 150 nm | 0.4 | — | — | 9:2 |
| Example 12 | | 85 nm | 0.6 | 2.4 | 150 nm | 0.5 | — | — | 6:5 |
| Example 13 | | 85 nm | 1 | 2.4 | 150 nm | 0.1 | — | — | 10:1 |
| Example 14 | | 85 nm | 0.9 | 2.4 | 150 nm | 0.2 | — | — | 9:2 |
| Comparative | 110° C. | — | — | 2.4 | 150 nm | 1.1 | — | — | — |
| Example 1 | | | | | | | | | |
| Comparative | | 85 nm | 1.1 | — | — | — | — | — | — |
| Example 2 | | | | | | | | | |
| Comparative | | 85 nm | 0.9 | — | — | — | 110 nm | 0.2 | 9:2 |
| Example 3 | | | | | | | | | |
| Comparative | | — | — | 2.4 | 150 nm | 0.2 | 110 nm | 0.9 | 9:2 |
| Example 4 | | | | | | | | | |
| Comparative | 125° C. | 85 nm | 0.9 | 2.4 | 150 nm | 0.2 | — | — | 9:2 |
| Example 5 | | | | | | | | | |

| | | | Evaluation | | | |
|---|---|---|---|---|---|---|
| | | Adhesion | Low | | | |
| | Bulk | strength | temperature | | | |
| Example | density | Si | offset | Filming | Transferability | Remarks |
| Example 1 | 0.41 | 68% | Good | Excellent | Excellent | Good |
| Example 2 | 0.40 | 67% | Good | Excellent | Excellent | Particle diameter relation + |
| | | | | | | larger particle diameter of |
| | | | | | | organic/inorganic |
| | | | | | | composite fine particles |
| Example 3 | 0.39 | 67% | Good | Good | Excellent | Particle diameter relation + |
| | | | | | | large particle diameter of |
| | | | | | | organic/inorganic |
| | | | | | | composite fine particles |
| Example 4 | 0.42 | 61% | Good | Good | Available | Small particle diameter of |
| | | | | | | organic/inorganic |
| | | | | | | composite fine particles |
| Example 5 | 0.38 | 69% | Good | Good | Excellent | Higher degree of |
| | | | | | | association |
| Example 6 | 0.38 | 59% | Good | Available | Excellent | High degree of |
| | | | | | | association |
| Example 7 | 0.38 | 62% | Good | Good | Excellent | Larger particle diameter of |
| | | | | | | associated silica |
| Example 8 | 0.38 | 58% | Good | Available | Excellent | Large particle diameter of |
| | | | | | | associated silica |
| Example 9 | 0.39 | 60% | Good | Available | Available | Small particle diameter of |
| | | | | | | associated silica |
| Example 10 | 0.38 | 69% | Good | Excellent | Available | Small parts by mass |
| Example 11 | 0.43 | 65% | Good | Available | Excellent | Large parts by mass |
| Example 12 | 0.39 | 69% | Good | Available | Excellent | Ratio (55%:45%) |
| Example 13 | 0.42 | 69% | Good | Available | Excellent | Ratio (91%:9%) |
| Example 14 | 0.36 | 75% | Good | Excellent | Available | Low AD + |
| | | | | | | High adhesion strength |
| Comparative | 0.38 | 68% | Good | Bad | Available | No organic/inorganic |
| Example 1 | | | | | | composite fine particles |
| Comparative | 0.39 | 69% | Good | Bad | Available | No associated |
| Example 2 | | | | | | silica |
| Comparative | 0.39 | 63% | Good | Bad | Good | Spherical |
| Example 3 | | | | | | Silica |
| Comparative | 0.41 | 62% | Good | Bad | Good | Spherical |
| Example 4 | | | | | | Silica |
| Comparative | 0.41 | 67% | BAD | Excellent | Excellent | High toner core |
| Example 5 | | | | | | softening point |

In all the Examples, excellent filming and transfer properties were obtained. Furthermore, there were differences in superiority among the Examples.

In Example 1, the particle diameter of the external additive A was relatively large, that is, 85 nm, and therefore, the result was that the filming and the transferability were most excellent. In Example 2, the particle diameter of the external additive A was larger than that in Example 1, and therefore, the filming was deteriorated. In Example 3, the particle diameter of the external additive A was smaller than that of Example 1, and therefore, the transferability was worsened and the slip-through was deteriorated. In Example 4, a degree of association of the external additive B was larger than that in Example 1, and therefore, the filming was deteriorated.

In Example 5, the particle diameter of the external additive B was smaller than that in Example 1, and therefore, the filming was deteriorated. In Example 6, the particle diameter of the external additive B was larger than that of Example 1, and therefore, the filming and the transferability were deteriorated and the slip-through was deteriorated. In Example 7, the parts by weight of the external additive A and the external additive B were smaller than those in Example 1, and therefore, the transferability was deteriorated.

In Example 8, the parts by weight of the external additive A and the external additive B were larger than those in Example 1, and therefore, the filming was deteriorated. In Example 9, a ratio of the external additive A was smaller than that in Example 1, and therefore, the filming was deteriorated.

In Example 10, the ratio of the external additive A was larger than that in Example 1, and therefore, the slip-through was deteriorated. In Example 11, the bulk density was smaller than that in Example 1, and therefore, the transferability was deteriorated.

In all the Comparative Examples in which the external additive A or B was not included, the result was that the filming and the transferability were poor. It is noted that in Comparative Example 1 in which only the associated silica was included in the external additive, the filming occurred. In Comparative Example 2 in which only the organic/inorganic composite fine particles were included in the external additive, the slip-through occurred.

In Comparative Examples 3 and 4 in which the spherical silica was added, the transferability was slightly improved, but not to the same extent as in the Examples.

As described above, in the toner and the image forming apparatus according to the present disclosure, it is possible to reduce the slip-through from the blade and reduce the filming.

It is noted that although each embodiment and each example of the present disclosure have been described in detail above, and it will be readily apparent to those skilled in the art that many modifications are possible without substantially departing from the novel points and effects of the present disclosure. Accordingly, all such modifications are intended to be included within the scope of this disclosure.

For example, a term described at least once in the specification or drawings together with a different term having a broader or similar meaning may be replaced by that different term anywhere in the specification or drawings. Furthermore, the configurations and operations of the toner and the image forming apparatus are not limited to those described in the embodiments and examples of the present disclosure, and various modifications are possible.

While there have been described what are at present considered to be certain embodiments of the disclosure, it will be understood that various modifications may be made thereto, and it is intended that the appended claims cover all such modifications as fall within the true spirit and scope of the disclosure.

What is claimed is:

1. A toner, comprising: toner particles and an external additive adhering to surfaces of the toner particles, wherein
the toner particle includes a crystalline polyester resin and a wax,
the external additive includes organic/inorganic composite fine particles and an associated silica having two or more primary particles being associated with each other, and
the toner has a softening point of 110° C. or lower.

2. The toner according to claim 1, wherein the organic/inorganic composite fine particles have a particle diameter of 70 to 200 nm.

3. The toner according to claim 1, wherein a degree of association of the associated silica is 2.0 to 3.0.

4. The toner according to claim 1, wherein a particle diameter of the associated silica is 100 to 300 nm.

5. The toner according to claim 1, wherein 1.0 to 1.2 parts by weight of the external additive is added externally to the toner particle.

6. The toner according to claim 1, wherein the organic/inorganic composite fine particles are included in an amount of 75 to 90 wt % relative to the external additive.

7. The toner according to claim 1, wherein a particle diameter of the organic/inorganic composite fine particles is smaller than a particle diameter of the associated silica.

8. The toner according to claim 1, wherein a bulk density of the toner is 0.38 or more.

9. The toner according to claim 1, wherein an adhesion strength of the external additive to the toner particle is 70% or less.

10. An image forming apparatus, comprising:
the toner according to claim 1;
an electrophotographic photoreceptor; and
an image former.
